(19) United States
(12) Patent Application Publication
(10) Pub. No.: US 2022/0049789 A1
(43) Pub. Date: Feb. 17, 2022

(54) Check Valve

(71) Applicant: OxiCool Inc., Malvem, PA (US)

(72) Inventor: Ravikant T. Barot, Phoenixville, PA (US)

(21) Appl. No.: 17/275,089

(22) PCT Filed: Sep. 26, 2019
(86) PCT No.: PCT/US2019/053265

§ 371 Date: Mar. 10, 2021

Related U.S. Application Data
(60) Provisional application No. 62/737,621, filed on Sep. 27, 2018.

(51) Int. Cl. F16K 31/08; F16K 15/18

(52) U.S. Cl. CPC F16K 31/088; F16K 15/1821

(57) ABSTRACT

Technologies are described herein for a check valve. The check valve can be operated using a lever and bellows system or an external magnet. External magnets external to the check valve move from a first position to open the check valve to a second position to close the check valve through the interaction of the magnetic fields of the external magnets and the internal magnet.

### BACKGROUND

Conventional valves can have some limitations. For example, in some industrial systems, contaminants entering the system can cause the degradation of the system. For example, in nuclear cooling systems, contaminants can become radioactive, increasing the radioactivity of the system. In another example, a chemical process can become corrupted if contaminants enter the system and undesirably react with the reactants in the system. In another example, various catalysts can become poisoned and unusable if contaminants are allowed to occupy reactive sites on the catalyst. There is a myriad of ways in which contaminants can enter a system.

It is with respect to these and other considerations that the disclosure made herein is presented.

### SUMMARY

Technologies are described herein for a check valve. In some examples, the check valve includes an encapsulated magnet in a shield. In some examples, external magnets external to the check valve move from a first position to open the check valve to a second position to close the check valve through the interaction of the magnetic fields of the external magnets and the internal magnet. In other examples, the check valve includes an external bellows that provides for the movement of an internal disc.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a side view of a valve according to an example of the presently disclosed subject matter.

FIG. 2 is a top down view of a valve according to an example of the presently disclosed subject matter.

FIG. 3 is a method for operating a check valve according to an example of the presently disclosed subject matter.

FIG. 4 illustrates an illustrative computer architecture for a device capable of executing the software components described herein for operating a check valve according to an example of the presently disclosed subject matter.

FIG. 5 is a front view of a valve according to an alternate example of the presently disclosed subject matter with a check valve in a closed configuration.

FIG. 6 is a front view of a valve according to an alternate example of the presently disclosed subject matter with a check valve in an open configuration.

### DETAILED DESCRIPTION

The following detailed description is directed to technologies for a check valve. In some examples, the valve includes a lever internal to the valve and a disc coupled to the lever. The disc, when seated against the valve seat, abates the flow of fluid and when off the valve seat, allows for the flow of fluid. In further examples, the valve includes a pivot allowing the lever to travel from a first position to a second position, wherein the first position is an open position whereby the disc is decoupled from a valve seat and wherein the second position is a closed position whereby the disc is coupled to the valve seat.

To move the valve, in some examples, the valve includes an internal magnet physically coupled to the lever. The internal magnet interacts with one or more magnets that are external to the valve to move the lever and disc from a first position to a second position, and from the second position to the first position. In further examples, to move the valve, the valve includes an internal rod physically coupled to the disc and an external lever enclosed within a deformable or flexible bellows.

In some examples, the check valve can be used in a system operating at a low to high vacuum. Although the presently disclosed subject matter is not limited to any definition of low vacuum or high vacuum, in some examples, a low vacuum can be defined as a pressure of 760 to 25 Torr, a medium vacuum can be defined as a pressure of 25 to 1×10−3 Torr, and a high vacuum can be defined as a pressure of 1×10−3 to 1×10−9 Torr. It should be noted, however, that the presently disclosed subject matter is not limited to use in a system operating at a vacuum.

In some uses, particular metals can be problematic in a vacuum. Metals for use in a vacuum should be resistant to or have a low probability of outgassing, as well as being tolerant to bake-out temperatures. Gas or other materials can be created in a vacuum-based system. For example, molecules of gases and water can be adsorbed on the material surface. Because of this, materials having a low affinity to water may need to be selected. Other materials may sublimate in a vacuum. In addition, gases can be released from porous metals or through cracks and crevices. Traces of lubricants or other cleaning compounds can also be a source of unwanted material in a system at vacuum.

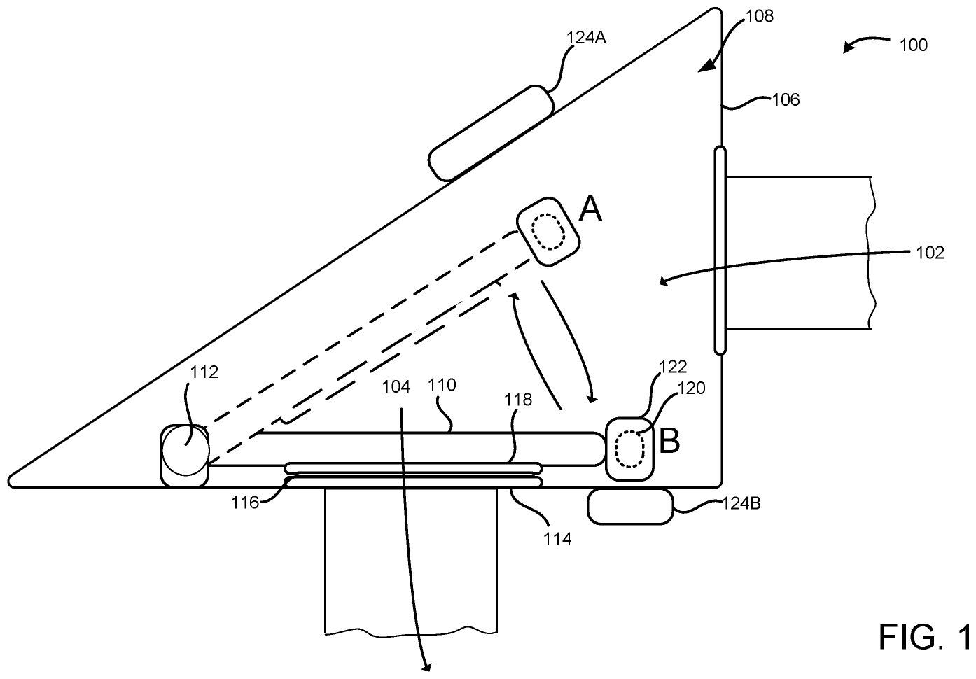

FIG. 1 is a side view of a valve 100 according to an example of the presently disclosed subject matter. As shown, the valve 100 is a check valve, though other types of valves may implement the subject matter disclosed herein and are considered to be within the scope of the present disclosure. The valve 100 includes an inlet 102 and an outlet 104. The outlet 104 and the inlet 102 are designed to facilitate the movement of fluid through the valve 100 when the valve 100 is in an open configuration. The valve 100 includes a valve body 106 that defines an inner volume 108 through which a fluid moves through the inlet 102 and out through the outlet 104.

The valve includes a lever 110. The lever 110 is rotatably connected to a pivot 112. The pivot 112 allows for the partial rotational movement of the lever 110 from a first position A, which is an open position and may be called a first configuration, to a second position B, which is a closed position and may be called a second configuration. In some examples, when the lever 110 is in the first position A, fluid may move into the valve 100 from the inlet 102 through the outlet 104.

The valve 100 further includes a valve seat 114 and a valve gasket 116. The valve gasket 116, as well as other gaskets, may be sealable material such as rubber, teflon, and the like. The valve seat 114 and the valve gasket 116 are designed to receive a disc 118 affixed to the lever 110. When in the second position B, the valve seat 114 and the valve gasket 116 are designed to receive the disc 118 to provide for the abatement of fluid moving through the valve 100.

To move the lever 110 from the first position A to the second position B, and from the second position B to the first position A, attached to the lever 110 is internal magnet 120 encapsulated within housing 122, which may act as a barrier or shield. The internal magnet 120 may be comprised of various materials. There are various types of magnets that may be used for the internal magnet 120. For example, the internal magnet 120 may be a neodymium-based magnet such as a neodymium iron boron magnet. A neodymium iron boron magnet is composed of rare earth magnetic material and has a high coercive force. Other types of magnets include, but are not limited to, magnets comprising the rare earth magnets and powders thereof. Some materials often contain neodymium, samarium, praseodymium, iron, cobalt, and other alloying elements such as aluminum, boron, carbon, chromium, copper, gallium, hafnium, manganese, niobium, tantalum, titanium, vanadium, zirconium, and the like. It should be noted, however, that the presently disclosed subject matter is not limited to the use of a specific magnet type, as various other types of magnets, including electromagnets, may be used.

Although not limited to any particular material, some materials that may be used for the housing 122 include, but are not limited austenitic stainless steels, mild steel, aluminum and aluminum alloys, aluminum, bronze, nickel, nickel alloys, beryllium, oxygen-free copper, brass, indium, gold, platinum, zirconium, tungsten, molybdenum, tantalum, titanium and niobium. In some examples, the thickness of the housing 122 around the internal magnet 120 can vary according to the particular application. For example, in applications in which plasma vapor deposition is used to coat the housing 122, the average thickness of the housing 122 (as measured from an outer surface of the housing 122 to an inner surface of the housing 122 proximate to and abutting the internal magnet 120) can range from 0.25 microns to over 5 microns. In some examples, if the housing 122 thickness can vary depending on the thickness of the material used to encapsulate the internal magnet 120.

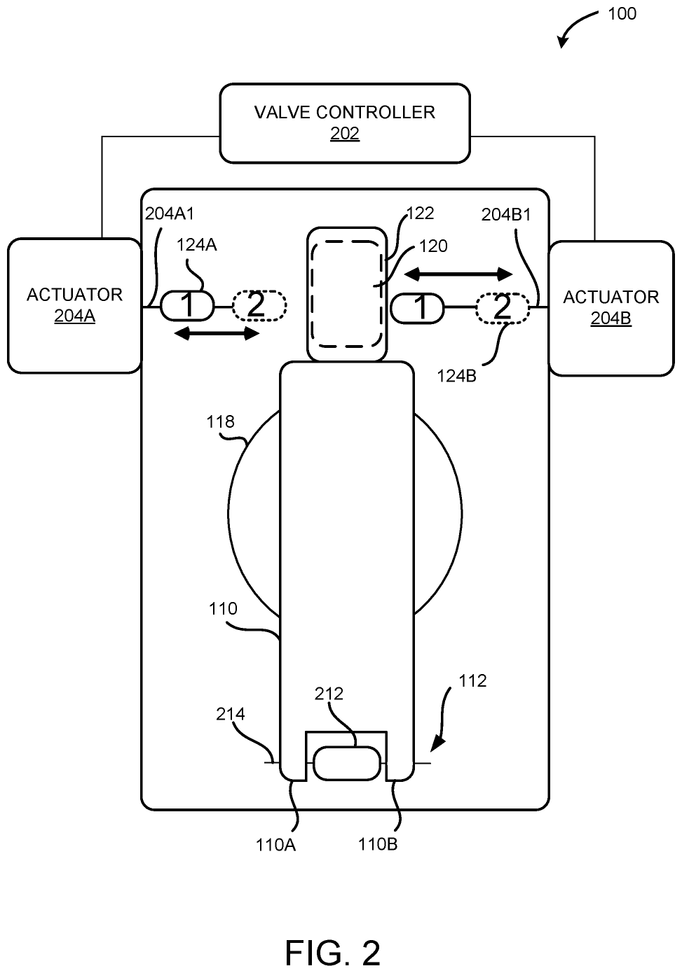

The internal magnet 120 is moved by the interaction of the magnetic field of the internal magnet 120 with external magnets 124A and 124B. The external magnets 124A and 124B move from a first position to a second position. The magnetic fields of the external magnets 124A and 124B either move the internal magnet 120 to position A or position B, as shown in further detail in FIG. 2. When the internal magnet 120 is either repulsed by the magnetic field of the external magnet 124B, or attracted to the magnetic field of the external magnet 124A, or both, the internal magnet 120 moves to position A. Because the housing 122 of the internal magnet 120 is affixed to the lever 110, the magnetic action causes the lever 110 to move to the position A.

In a similar manner, when the internal magnet 120 is either attracted to the magnetic field of the external magnet 124B, or repulsed by the magnetic field of the external magnet 124A, or both, the internal magnet 120 moves to position B. Because the housing 122 of the internal magnet 120 is affixed to the lever 110, the magnetic action causes the lever 110 to move to the position B.

FIG. 2 is a top down view of the valve 100. The valve 100 includes the lever 110 and the disc 118. The valve 100 further includes the internal magnet 120 encapsulated or enclosed within the housing 122. The valve 100 further includes the pivot 112. In the example illustrated in FIG. 2, the pivot 112 includes a pivot tower 212 and a pin 214 disposed through arms 110A and 110B of the lever 110, and through the pivot tower 212. The pin 214 allows the lever 110 to rotate about the pivot tower 212.

To move the lever 110 from an open position (position A as illustrated in FIG. 1) to a closed position (position B as illustrated in FIG. 1), or from a closed position (position B as illustrated in FIG. 1) to an open position (position A as illustrated in FIG. 1), the external magnet 124A is connected to an actuator 204A and the external magnet 124B is connected to an actuator 204B. The actuator 204A moves the external magnet 124A from a configuration 1 to a configuration 2, and from a configuration 2 to a configuration 1. In a similar manner, the actuator 204B moves the external magnet 124B from a configuration 1 to a configuration 2, and from a configuration 2 to a configuration 1. It should be noted that the use of two configurations is merely exemplary, as more than two configurations may be used.

In the example provided in FIG. 2, when the external magnet 124A and the external magnet 124B are in their respective configuration 2, the magnetic field of the internal magnet 120 attractively engages with the magnetic field of the external magnet 124A and disengages from the magnetic field of the external magnet 124B. Thus, when in their respective configuration 2, the internal magnet 120 will be attracted to the external magnet 124A, moving the lever 110 to position A illustrated in FIG. 1. When the external magnet 124A and the external magnet 124B are in their respective configuration 1, the magnetic field of the internal magnet 120 disengages from the magnetic field of the external magnet 124A and attractivity engages with the magnetic field of the external magnet 124B. Thus, when in their respective configuration 2, the internal magnet 120 will be attracted to the external magnet 124B, moving the lever 110 to position B illustrated in FIG. 1

To move the external magnet 124A and the external magnet 124B from configuration 1 to configuration 2, the actuators 204A and 204B are in electrical communication with a valve controller 202. The valve controller 202 receives instructions, or has instructions stored thereon, for actuating the actuators 204A and 204B. The actuators 204A and 204B can receive power from the valve controller 202, or can receive power from another source (not shown). The actuators 204A and 204B have arms 204A1 and 204B1 attached to the external magnet 124A and the external magnet 124B, respectively, to facilitate the movement.

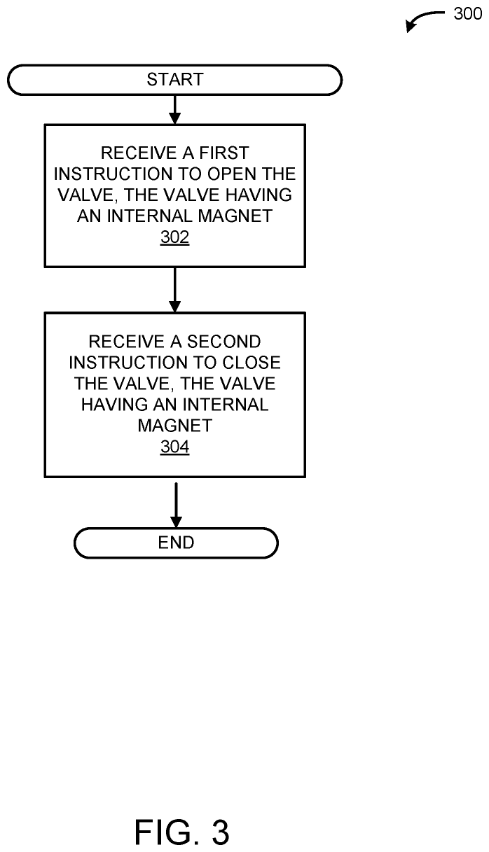

Turning now to FIG. 3, aspects of a method 300 for operating the valve 100, will be described in detail. It should be understood that the operations of the method 300 are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated method 300 can be ended at any time and need not be performed in its entirety. Some or all operations of the method 300, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like.

Computer-readable instructions can be implemented on various system configurations, including single-processor or multiprocessor systems, electronic control units, electronic control modules, programmable logic controllers, minicomputers, mainframe computers, personal computers, hand-held computing devices, microprocessor-based, programmable consumer electronics, combinations thereof, and the like. In some examples, instructions can be provided by a logic hard wired or hard encoded control system using relays, transistors, mosfets, logic gates, and the like. Computer-storage media does not include transitory media.

Thus, it should be appreciated that the logical operations described herein can be implemented as a sequence of computer implemented acts or program modules running on a computing system, and/or as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. For purposes of illustrating and describing the technologies of the present disclosure, the method 300 disclosed herein is described as being performed by the valve controller 202 and appropriate components of the valve 100, and the actuators 204A and 204B via execution of computer executable instructions. As such, it should be understood that the described configuration is illustrative, and should not be construed as being limiting in any way. Further, the following description of the method 300 is described in relation to FIGS. 1 and 2. However, it should be understood that this is merely an example, as the method may be used with other configurations.

The method 300 begins at operation 302, where the valve controller 202 receives an instruction to open the valve 100. The first instruction comprises instructions to move the external magnet 124A and the external magnet 124B to a first configuration, wherein in the first configuration, the magnetic force between the internal magnet 120, the external magnet 124A, and the external magnet 124B causes the lever 110 coupled to the internal magnet 120 to travel to an open position.

The method 300 continues to operation 304, where the valve controller 202 receives an instruction to close the valve 100. The second instruction comprises instructions to move the external magnet 124A and the external magnet 124B to a second configuration, wherein in the second configuration, the magnetic force between the internal magnet 120, the external magnet 124A, and the external magnet 124B causes the lever 110 coupled to the internal magnet 120 to travel to a closed position. The method 300 thereafter ends.

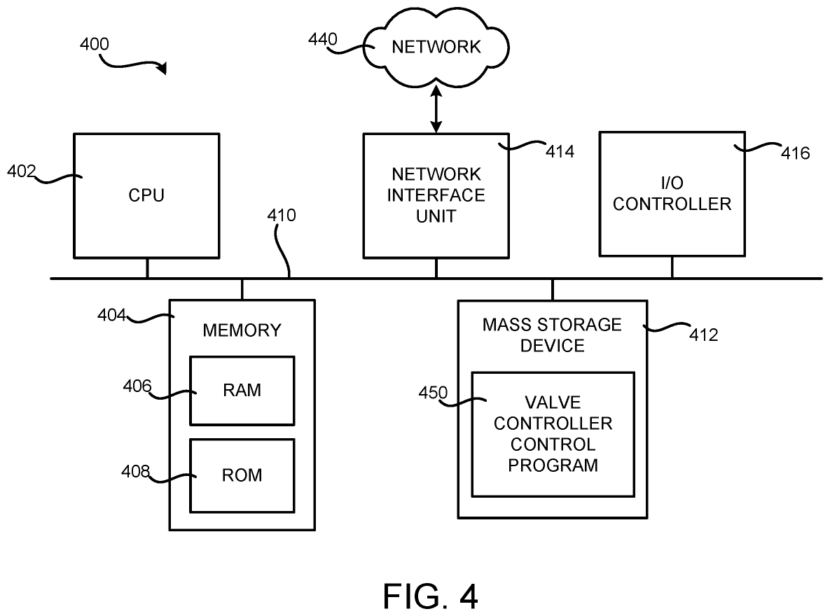

FIG. 4 illustrates an illustrative computer architecture 400 for a device capable of executing the software components described herein for operating a check valve. Thus, the computer architecture 400 illustrated in FIG. 4 illustrates an architecture for a server computer, onboard vehicle computer, mobile phone, a smart phone, a desktop computer, a netbook computer, a tablet computer, and/or a laptop computer. The computer architecture 400 may be utilized to execute any aspects of the software components presented herein.

The computer architecture 400 illustrated in FIG. 4 includes a central processing unit 402 (“CPU”), a system memory 404, including a random access memory 406 (“RAM”) and a read-only memory (“ROM”) 408, and a system bus 410 that couples the memory 404 to the CPU 402. A basic input/output system containing the basic routines that help to transfer information between elements within the computer architecture 400, such as during startup, is stored in the ROM 408. The computer architecture 400 further includes a mass storage device 412 for storing a valve controller control program 450 used to generate and send instructions to the valve controller 202. For example, the valve controller control program 450 may have instructions, which when implemented by the CPU 402, are used to control the valve 100.

The mass storage device 412 is connected to the CPU 402 through a mass storage controller (not shown) connected to the bus 410. The mass storage device 412 and its associated computer-readable media provide non-volatile storage for the computer architecture 400. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 400.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 400. For purposes the claims, a “computer storage medium” or “computer-readable storage medium,” and variations thereof, do not include waves, signals, and/or other transitory and/or intangible communication media, per se. For the purposes of the claims, “computer-readable storage medium,” and variations thereof, refers to one or more types of articles of manufacture.

According to various configurations, the computer architecture 400 may operate in a networked environment using logical connections to remote computers through a network such as the network 440. The computer architecture 400 may connect to the network 440 through a network interface unit 414 connected to the bus 410. It should be appreciated that the network interface unit 414 also may be utilized to connect to other types of networks and remote computer systems. The computer architecture 400 also may include an input/output controller 416 for receiving and processing input from a number of other devices, including a keyboard, mouse, or electronic stylus (not shown in FIG. 4). Similarly, the input/output controller 416 may provide output to a display screen, a printer, or other type of output device (also not shown in FIG. 4).

It should be appreciated that the software components described herein may, when loaded into the CPU 402 and executed, transform the CPU 402 and the overall computer architecture 400 from a general-purpose computing system into a special-purpose computing system customized to facilitate the functionality presented herein. The CPU 402 may be constructed from any number of transistors or other discrete circuit elements, which may individually or collectively assume any number of states. More specifically, the CPU 402 may operate as a finite-state machine, in response to executable instructions contained within the software modules disclosed herein. These computer-executable instructions may transform the CPU 402 by specifying how the CPU 402 transitions between states, thereby transforming the transistors or other discrete hardware elements constituting the CPU 402.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 400 in order to store and execute the software components presented herein. It also should be appreciated that the computer architecture 400 may include other types of computing devices, including hand-held computers, embedded computer systems, personal digital assistants, and other types of computing devices known to those skilled in the art. It is also contemplated that the computer architecture 400 may not include all of the components shown in FIG. 4, may include other components that are not explicitly shown in FIG. 4, or may utilize an architecture completely different than that shown in FIG. 4.

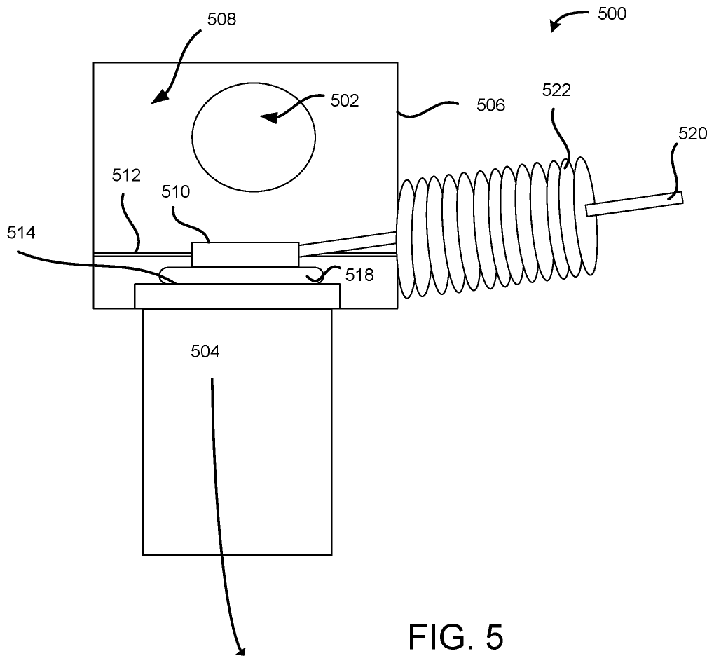

FIG. 5 is a front view of a valve 500 according to an alternate embodiment of the presently disclosed subject matter. As shown, the valve 100 is a check valve, though other types of valves may implement the subject matter disclosed herein and are considered to be within the scope of the present disclosure. The valve 500 includes an inlet 502 and an outlet 504. The outlet 504 and the inlet 502 are designed to facilitate the movement of fluid through the valve 500 when the valve 500 is in an open configuration. The valve 500 includes a valve body 506 that defines an inner volume 508 through which a fluid moves through the inlet 502 and out through the outlet 504.

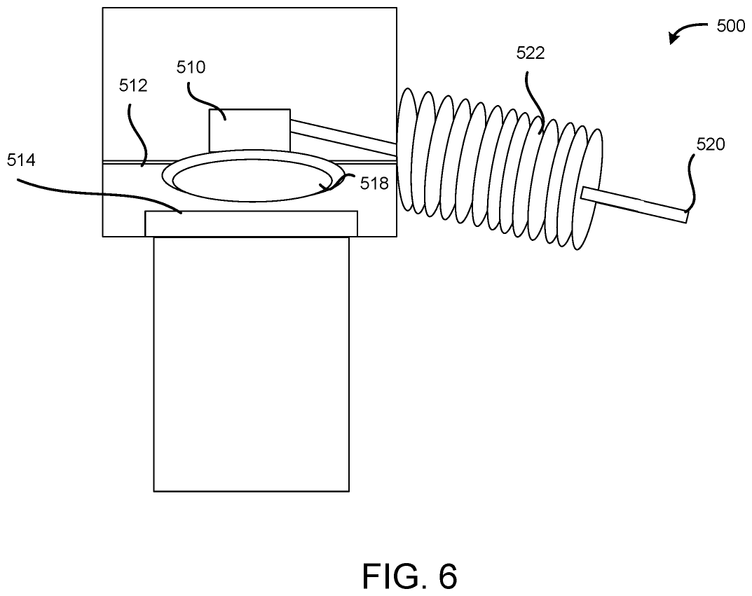

The valve includes a lever 510. The lever 510 is rotatably connected to a pivot 512. The pivot 512 allows for the partial rotational movement of the lever 510 from a closed position (illustrated in FIG. 5) to a closed position (illustrated in FIG. 6). In some examples, when the lever 510 is in the closed position illustrated in FIG. 5, a valve seat 514 is designed to receive a disc 518 to provide for the abatement of fluid moving through the valve 500.

To move the valve 500 from the closed position illustrated in FIG. 5 to the open position in FIG. 6, the valve 500 further includes a movement lever 520 and bellows 522. The bellows 522 is flexible to allow for the movement of the movement lever 520 from the position illustrated in FIG. 5 (providing for the closed position) to the position illustrated in FIG. 6 (providing for the open position). The movement lever 520 extends through the bellows 522, through the valve body 506 and is attached to the lever 510. The bellows 522 is sealed, in some examples, hermetically, to the valve body 506 and the around the movement lever 520 to provide for barrier between the inner volume 508 and atmosphere around the valve 500. In some examples, the interface between the movement lever 520 and the valve body 506 is also sealed, providing multiple barriers between the inner volume 508 and atmosphere around the valve 500.

FIG. 6 is a front view of the valve 500 in an open position. In FIG. 6, the movement lever 520 has been moved from the position illustrated in FIG. 5 (the closed position) to the position illustrated in FIG. 6. The change in position of the movement lever 520 places an upward force on the lever 510, causing the lever 510 to rotate about the pivot 512. The rotation about the pivot 512 forces the lever 510 upwards, moving the disc 518 off the valve seat 514, allowing for the flow of fluid through the valve. The movement lever 520 may be moved back to the position illustrated in FIG. 5 to close the valve, or in the case of other types of valves such as a throttle valve, a position between the open and closed position.

Based on the foregoing, it should be appreciated that technologies for a solenoid valve having a fully encapsulated magnetic core have been disclosed herein. It is to be understood that the invention defined in the appended claims is not necessarily limited to the specific features or acts described herein. Rather, the specific features or acts are disclosed as example forms of implementing the claims.

The subject matter described above is provided by way of illustration only and should not be construed as limiting. Various modifications and changes can be made to the subject matter described herein without following the example configurations and applications illustrated and described, and without departing from the true spirit and scope of the present invention, aspects of which are set forth in the following claims.

1. A valve, comprising:
a lever internal to the valve;
a disc coupled to the lever;
a pivot allowing the lever to travel from a first position to a second position, wherein the first position is an open position whereby the disc is decoupled from a valve seat and wherein the second position is a closed position whereby the disc is coupled to the valve seat;
an internal magnet physically coupled to the lever; and
an external magnet magnetically couplable to the lever, wherein in a first position a magnetic force between the internal magnet and the external magnet causes the lever to travel to the first position and in a second position the magnetic force between the internal magnet and the external magnet causes the lever to travel to the second position.

2. The valve of claim 1, wherein the internal magnet comprises neodymium encapsulated in a housing.

3. The valve of claim 1, wherein the internal magnet comprises samarium cobalt, alnico, ceramic, or ferrite.

4. The valve of claim 1, wherein the internal magnet comprises neodymium encapsulated in a shield.

5. The valve of claim 1, wherein the internal magnet comprises samarium cobalt, alnico, ceramic, or ferrite.

6. The valve of claim 1, wherein the valve seat comprises a rubber gasket.

7. The valve of claim 1, further comprising a second external magnet, wherein in a third position the magnetic force between the internal magnet, the external magnet, and the second external magnet causes the lever to travel to the first position and in a fourth position the magnetic force between the internal magnet, the external magnet, and the second external magnet causes the lever to travel to the second position.

8. The valve of claim 1, further comprising an actuator to move the external magnet from the first position to the second position.

9. A check valve, comprising:
a valve body having an inlet port through which fluid is introduced and an outlet port through which fluid is discharged;
a lever internal to the valve body;
an internal magnet physically coupled to the lever;
a disc coupled to the lever;
a pivot allowing the lever to travel from a first position to a second position, wherein the first position is an open position whereby the disc is decoupled from a valve seat to allow for fluid flow and wherein the second position is a closed position whereby the disc is coupled to the valve seat to abate fluid flow; and
a first external magnet and a second external magnet magnetically couplable to the lever, wherein in a first configuration a magnetic force between the internal magnet, the external magnet, and the second external magnet causes the lever to travel to the first position and in a second configuration the magnetic force between the internal magnet, the external magnet, and the second external magnet causes the lever to travel to the second position.

10. The check valve of claim 9, wherein the internal magnet comprises neodymium encapsulated in a housing.

11. The check valve of claim 9, wherein the internal magnet comprises samarium cobalt, alnico, ceramic, or ferrite.

12. The check valve of claim 9, wherein the internal magnet comprises neodymium encapsulated in a shield.

13. The check valve of claim 9, wherein the internal magnet comprises samarium cobalt, alnico, ceramic, or ferrite.

14. The check valve of claim 9, wherein the valve seat comprises a rubber gasket.

15. The check valve of claim 9, further comprising a first actuator to move the first external magnet and a second actuator to move the second external magnet from the first configuration to the second configuration and from the second configuration to the first configuration.

16. A system comprising:
a non-transitory storage medium; and
instructions stored in the non-transitory storage medium, the instructions being executable by the system to:
receive at a valve controller a first instruction to open a check valve, the first instruction to open a check valve comprising instructions to move a first external magnet and a second external magnet that are magnetically coupled to an internal magnet of the check valve to a first configuration, wherein in the first configuration, a magnetic force between the internal magnet, the external magnet, and the second external magnet causes a lever coupled to the internal magnet to travel to an open position; and
receive at the valve controller a second instruction to open a check valve, the second instruction to open the check valve comprising instructions to move the first external magnet and the second external magnet that are magnetically coupled to the internal magnet of the check valve to a second configuration, wherein in the second configuration, the magnetic force between the internal magnet, the external magnet, and the second external magnet causes a lever coupled to the internal magnet to travel to a closed position.

17. A check valve, comprising:
a valve body having an inlet port through which fluid is introduced and an outlet port through which fluid is discharged;
a lever internal to the valve body;
a disc coupled to the lever;
a movement lever coupled to the lever, the movement lever disposed through a flexible bellows and the valve body, wherein the movement lever is sealed; and
a pivot allowing the lever to travel from a first position to a second position, wherein the first position is an open position whereby the disc is decoupled from a valve seat to allow for fluid flow and wherein the second position is a closed position whereby the disc is coupled to the valve seat to abate fluid flow, and wherein a first position of the movement lever causes the lever to travel from the first position to the second position and a second position of the movement lever causes the lever to travel from the second position to the first position.
